(19) United States
(12) Patent Application Publication
(10) Pub. No.: US 2006/0126220 A1
(43) Pub. Date: Jun. 15, 2006

(54) Disk drive device

(75) Inventors: Fusatoshi Okamoto, Oozu-shi (JP); Hisaaki Yano, Oozu-shi (JP); Kaoru Uenosono, Oozu-shi (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/259,074

(22) Filed: Oct. 27, 2005

(30) Foreign Application Priority Data
Dec. 10, 2004 (JP) 2004-357475

(51) Int. Cl. G11B 17/02

(52) U.S. Cl. 360/99.12

(57) ABSTRACT

A recess (27) is formed in a hub flange surface (21) concentrically with a rotation center axis of a spindle hub (7). The hub flange surface (21) contacts a disk surface (20) at positions on opposite sides of the recess (27) in a radial direction of the disk.

### FIELD OF THE INVENTION

The present invention relates to a disk drive device which drives and rotates a magnetic disk, an optical disk or the like by means of a spindle motor and, more particularly, to a technique relating to a hub structure for mounting a disk.

### BACKGROUND OF THE INVENTION

In recent years, with the increase in recording density of disk recording mediums such as optical disks or the like, disk recording mediums have become smaller. For example, minimization from 3.5-inch disks to 2.5-inch disks, from 2.5-inch disks to 1.8-inch disks and from 1-inch disks to 0.85-inch disks have been effected.

With the minimization of disk recording mediums and hard disk drives (HDD) in which disk recording mediums are mounted, there has been a demand for the minimization and slim thickness of disk drive devices for driving and rotating disk recording mediums.

A disk drive device has a spindle motor and a hub rotating with the spindle of the spindle motor. The hub is fitted in a disk center hole of a disk recording medium, and supported around the disk center hole on the hub flange surface. The disk recording medium placed on the hub flange surface is fixed on the hub flange surface by a clamping means such as a screw. In the disk drive device, the spindle of the spindle motor is rotated to drive and rotate the disk recording medium on the rotation center axis of the spindle.

In this disk drive device, there is a need to horizontally maintain the disk surface of the disk recording medium in the state where the disk recording medium is fixed on the hub flange surface. In other words, it requires mounting the disk recording medium on the hub flange surface so that the disk surface of the disk recording medium is straight, that is, the desired straightness (horizontality) of the disk surface is maintained in a direction perpendicular to the rotation center axis of the spindle.

For example, the straightness of the disk recording medium is impaired when the disk recording medium has the deflection by a clamping force produced by the clamping means. If the straightness is impaired, the ability of a head to follow a track on the disk recording medium is thereby reduced and the frequency of retrial due to misreading is increased, resulting in a reduction in response speed.

An arrangement disclosed in Japanese Utility Model Registration No. 2562727 is a solution to this problem. This arrangement will be outlined below.

As shown in FIG. 8, a hub flange mount surface 52 of a hub 51 is formed so as to be lower at an inner peripheral side than at an outer peripheral side and so as to be gradually increased in height from the inner peripheral side to the outer peripheral side. A difference in height h1 is set between an inner peripheral portion 52a and an outer peripheral portion 52b.

In this arrangement, a disk recording medium is placed on the hub flange surface 52 and a screw provided as a clamping means is screwed to clamp the disk recording medium on the hub flange surface 52.

As the result, the outer peripheral portion 52b displaces by the deflection at the hub flange surface 52, and the inner peripheral portion 52b and the outer peripheral portion 52a become equal in height to each other, thus improving the straightness (horizontality) of the hub flange surface 52 and the disk recording medium.

An arrangement disclosed in U.S. Pat. No. 5,089,922 is another solution to the above-described problem. This arrangement will be outlined below.

As shown in FIG. 9, a raised portion 63 circular in section is provided on an outer peripheral portion of a disk mount flange 62 of a hub 61. A disk recording medium 65 is mounted on the disk mount flange 62, with a disk center hole of the disk recording medium 65 fitted around a cylindrical portion 66 of the hub 61. A plurality of disk recording mediums 65 are stacked one on another with spacers 64 interposed therebetween. The disk recording medium 65 at the lowermost position is held by the raised portion 63.

In this arrangement, the disk recording mediums 65 mounted on the disk mount flange 62 are fixed by being clamped by a clamping device.

The hub flange surface 62 has thereby deflection to displace the raised portion 63 on the outer peripheral portion. However, the outer peripheral surface circular in section of the raised portion 63 contacts the disk recording medium 65 and line contact between the outer peripheral surface and the disk recording medium 65 is maintained, thereby maintaining the straightness (horizontality) of the disk recording medium 65.

In the above-described conventional arrangements, a condition described below is required to maintain the straightness of the disk recording medium when the clamping force of the clamping device is imparted to the disk recording medium.

It is necessary to accurately impart the clamping force of the clamping device to the supporting portion in line contact with the disk recording medium. The supporting portion is the outer peripheral portion 52b of the hub 1 in the arrangement disclosed in Japanese Utility Model Registration Publication No. 2562727, or the raised portion 63 of the disk mount flange 62 in the arrangement disclosed in U.S. Pat. No. 5,089,922.

However, there is variation in the accuracy with which a component of the clamping device is worked, and variation in clamping force of the clamping device results from the variation in working accuracy. For example, if the point of loading from the clamping device deviates from the supporting portion of the hub, an excessive force or an unbalanced load acts on the disk recording medium. In such a case, the hub is not warped in accordance with a condition supposed in advance. As a result, the straightness of the disk recording medium is impaired.

In view of the above-described problem, an object of the present invention is to provide a disk drive device in which a bending moment acting on a disk recording medium is reduced by dispersing a load applied to a hub by the clamping force of a clamping device, and which is therefore capable of limiting a warp (inclination) caused in the disk recording medium due to variation in the accuracy with which a component of the clamping device is worked or variation in claming force of the clamping device.

### DISCLOSURE OF THE INVENTION

To achieve the above-described object, according to the present invention, there is provided a disk drive device including a spindle hub on which a disk recording medium is mounted, and a clamping device for fixing the disk recording medium to the spindle hub, the spindle hub being fitted in a disk center hole formed at a center of the disk recording medium, the spindle hub having a hub flange surface on which a disk surface of the disk recording medium is supported concentrically with the disk center hole, the clamping device imparting a clamping force to the hub flange surface through the disk recording medium, wherein a recess is formed in the hub flange surface concentrically with a rotation center axis of the spindle hub, and the hub flange surface contacts the disk surface at positions on opposite sides of the recess in a radial direction of the disk recording medium.

The clamping force of the clamping device is imparted to the disk recording medium at a position opposite from the recess in the hub flange surface.

The clamping device has a contact portion through which the clamping force is imparted to the disk recording medium, and the contact portion has a curved surface and contacts the disk recording medium in line contact in the curved surface.

According to the present invention, there is also provided a spindle motor including a spindle hub on which a disk recording medium is mounted, the spindle hub being fitted in a disk center hole formed at a center of the disk recording medium, the spindle hub having a hub flange surface on which a disk surface of the disk recording medium is supported concentrically with the disk center hole, a recess being formed in the hub flange surface concentrically with a rotation center axis of the spindle hub.

According to the present invention, as described above, the disk recording medium to which the clamping force of the clamping device is imparted is supported at least at two positions in the radial direction of the disk. Advantages described below are thereby obtained.

In the present invention, the clamping force of the clamping device is imparted to the hub flange surface while being dispersed, thereby reducing a bending moment acting on the disk recording medium relative to that acting on the disk recording medium in the conventional structure in which the disk recording medium is supported through line contact with the supporting portion.

In particular, the clamping force of the clamping device acts on the disk recording medium at the position corresponding to the recess. In this way, the disk recording medium is supported at two points as seen in the radial direction of the disk against the clamping force of the clamping device. Therefore, a warp caused in the disk recording medium by the clamping force of the clamping device can be limited to maintain the straightness of the disk surface of the disk recording medium in a direction perpendicular to the rotation center axis of the spindle.

Also, when the clamping force of the clamping device is imparted to the disk recording medium at the position corresponding to the recess, the straightness of the disk surface can be maintained if the clamping device contacts the disk recording medium in the region (width) corresponding to the recess in the radial direction of the disk. That is, the load point on the disk surface to which the clamping force of the clamping device is imparted may be set to any position in the region corresponding to the recess. Therefore, a reduction in the load position positioning accuracy may be allowed. Consequently, even if there is variation in the accuracy of a component of the claming device or variation in clamping force of the clamping device, the desired straightness (horizontality) of the disk surface of the disk recording medium can be easily maintained, thus reducing the occurrence of defectives and achieving an improvement in yield and a reduction in manufacturing cost.

### BRIEF DESCRIPTION OF THE DRAWINGS

FIG. 1 is a cross-section view of a disk drive device in an embodiment of the present invention;

FIG. 2 is an enlarged cross-section view of an essential portion of the disk drive device in the embodiment of the present invention;

FIG. 3 is an enlarged cross-section view of the hub flange surface of the disk drive device in the embodiment of the present invention;

FIG. 4 is an enlarged cross-section view of a hub flange surface of a conventional disk drive device;

FIG. 5 is a diagram schematically showing a mechanical model of the disk drive device in the embodiment of the present invention;

FIG. 6 is a diagram schematically showing a mechanical model of the conventional disk drive device;

FIG. 7 is a graph of comparison of displacement occurring in the direction of height in a disk recording medium, between the disk drive device in the embodiment of the present invention and the conventional disk drive device;

FIG. 8 is an enlarged cross-section view of the hub flange surface in the conventional disk drive device; and

FIG. 9 is an enlarged cross-section view of a hub flange surface in another conventional disk drive device.

### DESCRIPTION OF THE EMBODIMENT

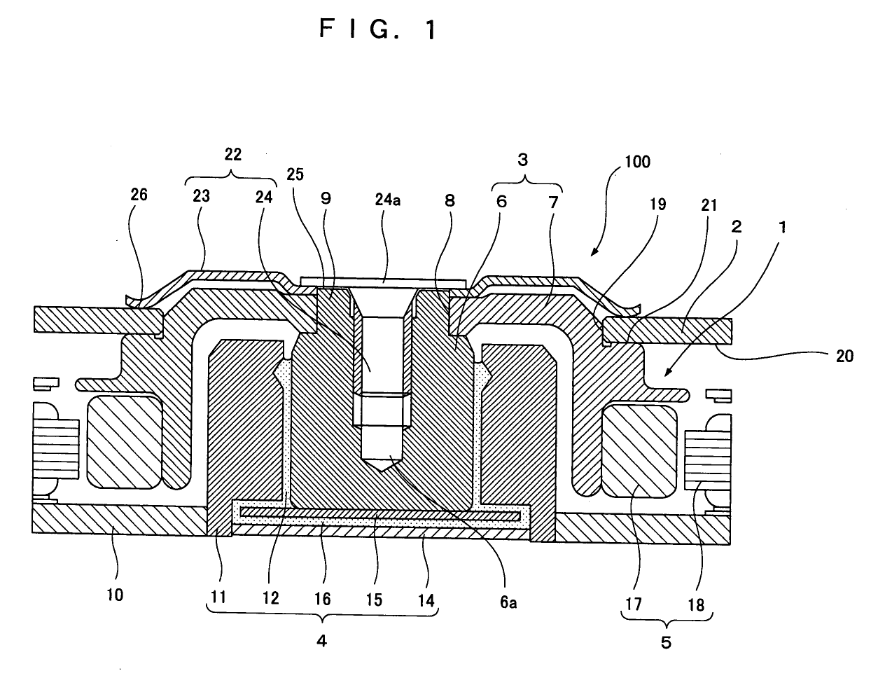

An embodiment of the present invention will be described with reference to the drawings. Referring to FIG. 1, a disk drive device 100 drives and rotates a recording medium 2 by a spindle motor 1. The disk recording medium 2 is a magnetic disk or an optical disk on which information is recorded.

The spindle motor 1 includes a spindle 3, a bearing 4 and a drive portion 5. The spindle 3 has a shaft 6 which rotates about an axis, and a spindle hub 7 which rotates integrally with the shaft 6. The spindle hub 7 has a hub center hole 8 at its center. A shaft boss 9 of the shaft 6 is fitted in the hub center hole 8.

In this embodiment, the bearing portion 4 is a fluid dynamic bearing. In the bearing portion 4, a sleeve 11 fixedly placed on a base 10 is loosely fitted around the shaft 6. A predetermined gap 12 is formed between an inner peripheral surface of the sleeve 11 and an outer peripheral surface of the shaft 6 and is filled with a lubricating oil 13. The lubricating oil 13 and the sleeve 11 form a radial bearing.

In the bearing portion 4, an opening of the sleeve 11 on the base side is closed by a thrust plate 14, and a thrust flange 15 provided at an end of the shaft 6 is opposed to the thrust plate 14. During operation, a predetermined gap 16 is formed between the thrust plate 14 and the thrust flange 15. This predetermined gap 16 is filled with lubricating oil 13. This lubricating oil 13, the thrust plate 14 and the thrust flange 15 form a thrust bearing.

In the present invention, the bearing portion 4 is not limited to the fluid bearing. Any other bearing structure such as a roller bearing may be applied to the bearing portion 4.

The drive portion 5 includes a rotor magnet 17 and a stator core 18. The rotor magnet 17 is provided on an outer peripheral portion of the spindle hub 7, while the stator core 18 is fixedly placed on the base 10. The spindle 3 is rotated by a rotating drive force generated in the drive portion 5.

The disk recording medium 2 has a disk center hole 19 at its center and is fitted to the spindle hub 7, with the disk center hole 19 being fitted around a portion of the spindle hub 7. The spindle hub 7 has a hub flange surface 21 on which a portion of a disk surface 20 of the disk recording medium 2 around the disk center hole 19 is supported.

A clamping device 22 is constituted by a clamp 23 and a clamp screw 24 from which a clamping force is imparted to the clamp 23. The clamp 23 has a clamp center hole 25 at its center and is fitted to the shaft boss 9, with the clamp center hole 25 being fitted around the shaft boss 9. The clamp screw 24 is attached by being screwed into a shaft threaded hole 6a formed in the shaft 6.

A head 24a of the clamp screw 24 contacts the clamp 23, and a contact portion 26 of the clamp 23 formed along the outer peripheral edge of the clamp 23 contacts the disk recording medium 2. A clamping force produced by driving the clamp screw 24 acts on the disk recording medium 2 through the clamp 23.

The contact portion 26 of the clamp 23 has a curved surface which is curved as seen in cross section. The curved surface of the contact portion 26 contacts the disk recording medium 2 in a line contact. The clamp 23 forms a circular load-point line on the disk recording medium 2 by the contact portion 26 to press the disk recording medium 2 uniformly in the circumferential direction.

The structure of the clamping device 22 is not limited to that in this embodiment. Any of other clamp structures may alternatively be adopted.

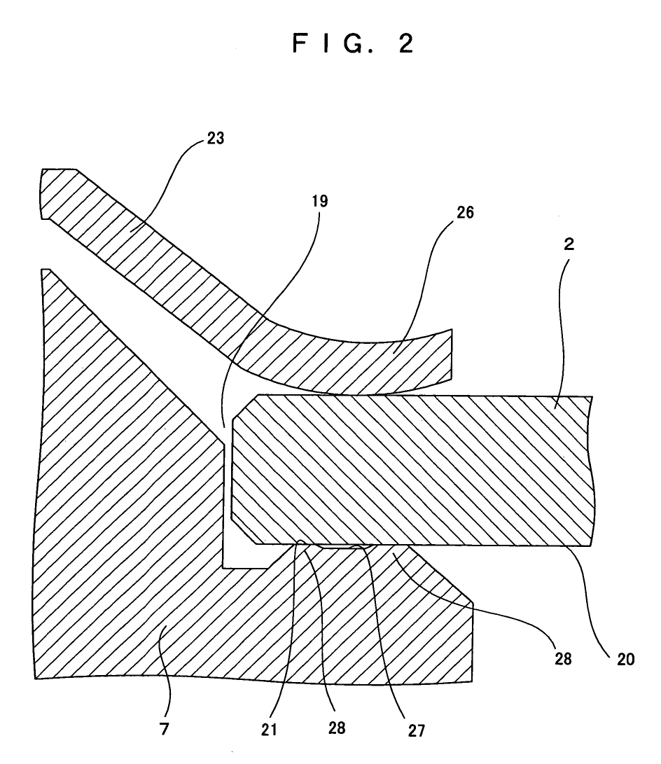

As shown in FIG. 2, the spindle hub 7 has a recess 27 in the hub flange surface 21. The recess 27 is formed so as to be annular along a circle about the rotation center axis of the spindle hub 7.

The hub flange surface 21 has supporting projections 28 formed on opposite sides of the recess 27 as seen in the radial direction of the disk. The disk supporting projections of the hub flange surface 21 contact the disk surface 20.

The recess 27 of the hub flange surface 21 has a predetermined depth. It is desirable that the recess 27 be so deep that the disk recording medium 2 does not contact the bottom surface of the recess even when the disk recording medium 2 is warped. However, there is no problem even if the disk recording medium 2 can contact the bottom surface of the recess. The recess 27 may have a rectangular or circular-arc sectional shape and may alternatively have any other sectional shape.

In other words, the form of the hub flange surface 21 having the recess 27 is such that the hub flange surface 21 has a plurality of disk supporting projections 28 formed concentrically with each other and each having an annular shape concentric with the rotation center axis of the spindle hub 7, the recess 27 being formed between the disk supporting projections 28 as seen in the radial direction.

While one recess 27 is formed in the hub flange surface 21 in this embodiment, it is also possible to provide two or more recesses 27.

As described above, in this embodiment, the pair of disk supporting projections 28, between which the recess 27 is formed in the hub flange surface 21, supports the disk surface 20 of the disk recording medium 2. Further, the contact portion 26 of the clamp 23 contacts the disk recording medium 2 in a line contact at a position opposite from the recess 27, i.e., between the pair of disk supporting projections 28.

In this state, the clamping force of the clamping device 22 acts on the disk recording medium 2 through the contact portion 26 of the clamp 23, and the clamp 23 presses the disk recording medium 2 at the circular-load-point line. The recording medium 2 is thereby pressed uniformly in the circumferential direction.

The clamping force of the claming device 22 is received by the disk supporting projections 28 of the hub flange surface 21 on the opposite sides of the recess 27 in the radial direction of the disk. Consequently, the clamping force of the claming device 22 acts on the hub flange surface 21 while being dispersed.

The disk recording medium 2 to which the clamping force of the clamping device 22 is imparted is supported by the disk supporting projections 28 at least at two positions in the radial direction of the disk, as described above. Advantages described below are thereby obtained.

A bending moment acting on the disk recording medium 2 in this embodiment is smaller than that produced on the disk recording medium 2 in the conventional structure in which the disk recording medium 2 is supported by the hub flange surface 21 in one place, and in which the hub flange surface 21 is sloping.

In particular, the clamping force of the clamping device 22 acts on the disk recording medium 2 between the pair of disk supporting projections 28. In this way, the disk recording medium 2 is supported at two points as seen in the radial direction of the disk against the clamping force of the clamping device 22.

Therefore, a warp caused in the disk recording medium 2 by the clamping force of the clamping device 22 can be limited to maintain the straightness of the disk surface of the disk recording medium 2 in the direction perpendicular to the rotation center axis of the spindle 3.

The bending moment produced on the disk recording medium 2 comes to a beam bending moment problem in the strength of materials, and it is apparent from the viewpoint of mechanics that the present invention using a multipoint support is more advantageous.

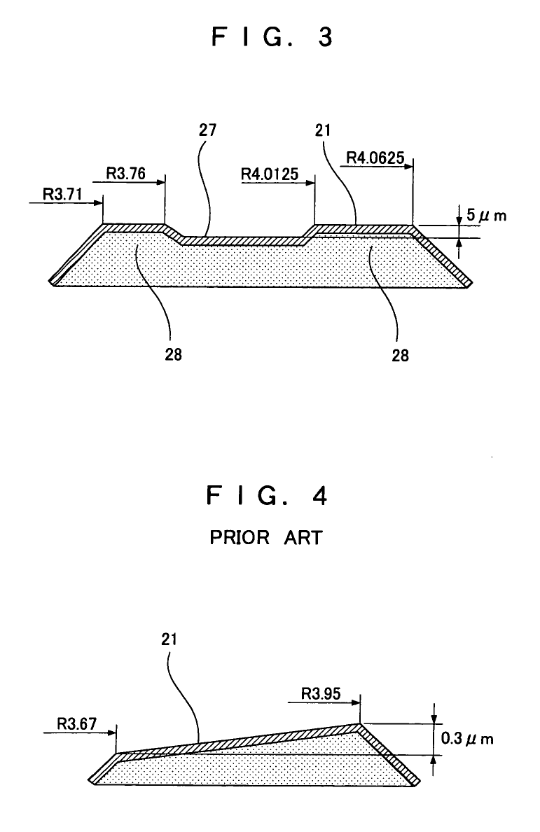

The present invention will be described in further detail with reference to FIGS. 3 to 7. FIG. 3 is a cross-section view showing the hub flange surface 21 in an implementation of the present invention, and FIG. 4 is a cross-section view showing as a comparative example a case where the hub flange surface 21 is sloping.

Referring to FIG. 3, the depth of the recess 27 is 5 μm from the hub flange surface 21. The distance (in mm) from the rotation center axis of the spindle hub 7 to each portion is as shown below. The distance to the inner peripheral edge of the hub flange surface 21 is R3.71; the distance to the inner peripheral edge of the recess 27 is R3.76; the distance to the outer peripheral edge of the recess 27 is R4.0125; and the distance to the outer peripheral edge of the hub flange surface 21 is R4.0625.

The size of the hub flange surface 21 varies depending on the HDD size. For example, the inner peripheral edge size of the hub flange surface 21 is in the range from about R3.0 to R14.0, and the outer peripheral edge size of the hub flange surface 21 is in the range from about R3.4 to R16.0. Therefore, the shape of the hub flange surface 21 is not limited to that defined by the above-mentioned size.

Accordingly, the width of the recess 27 can also be changed. Also, the suitable value of the depth of the recess 27 varies depending on the clamping force or the disk rigidity. For example, the depth of the recess 27 may be 0.3 μm or more and is not limited to the above-mentioned size.

Referring to FIG. 4, the distance (in mm) from the rotation center axis of the spindle hub 7 to each portion is as shown below. The distance to the inner peripheral edge of the hub flange surface 21 is R3.67; the distance to the outer peripheral edge of the hub flange surface 21 is R3.95; and the difference between the heights of the inner and outer peripheral edges of the hub flange surface 21 (slope) is 0.3 μm.

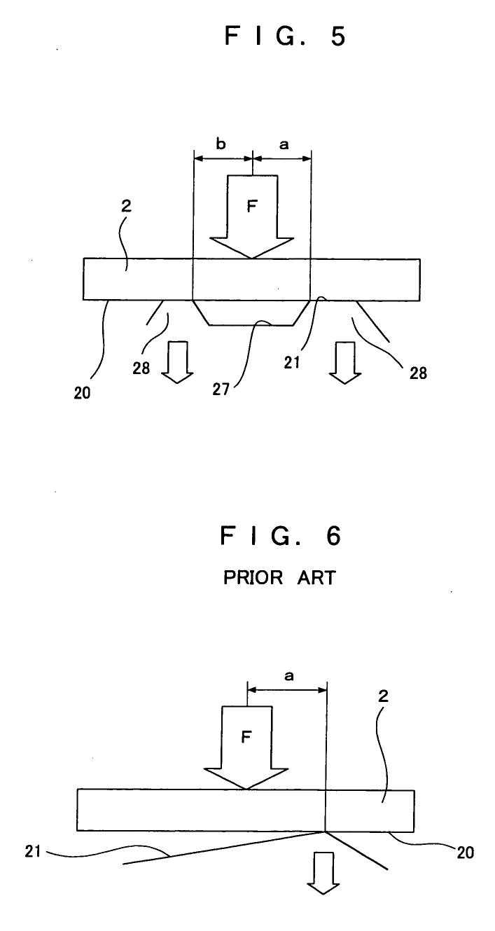

Disk recording mediums 2 are mounted on the hub flange surfaces 21 shown in FIGS. 3 and 4, and the clamping force of the clamping device 22 is imparted to the disk recording medium 2. FIGS. 5 and 6 show the states how the clamping forces are imparted.

Referring to FIG. 5, the load F produced by the clamping force of the clamping device 22 is applied between the inner and outer peripheral edges of the recess 27. The load point is at a distance a from the outer peripheral edge of the recess 27 and at a distance b from the inner peripheral edge of the recess 27.

Referring to FIG. 6, the load F produced by the clamping force of the clamping device 22 is applied between the inner and outer peripheral edges of the hub flange surface 21. The load point is at a distance a from the outer peripheral edge of the hub flange surface 21.

Referring to FIG. 5, the load F from the clamping device 22 is dispersed and one of the points of application is on the rotation center axis side of the load point. The maximum bending moment M1 on the disk recording medium 2 is F×a×b/(a+b).

Referring to FIG. 6, the load F from the clamping device 22 is entirely applied to the outer peripheral edge of the hub flange surface 21. The maximum bending moment M2 on the disk recording medium 2 is F×a.

Therefore, M1=F×a×b/(a+b)<F×a is =M2. The maximum bending moment M1 in the case of two-point support is smaller than the maximum bending moment M2 in the case of one-point support. As a result, variation in the amount of warp (inclination) caused in the disk recording medium 2 is reduced.

[Table 1]

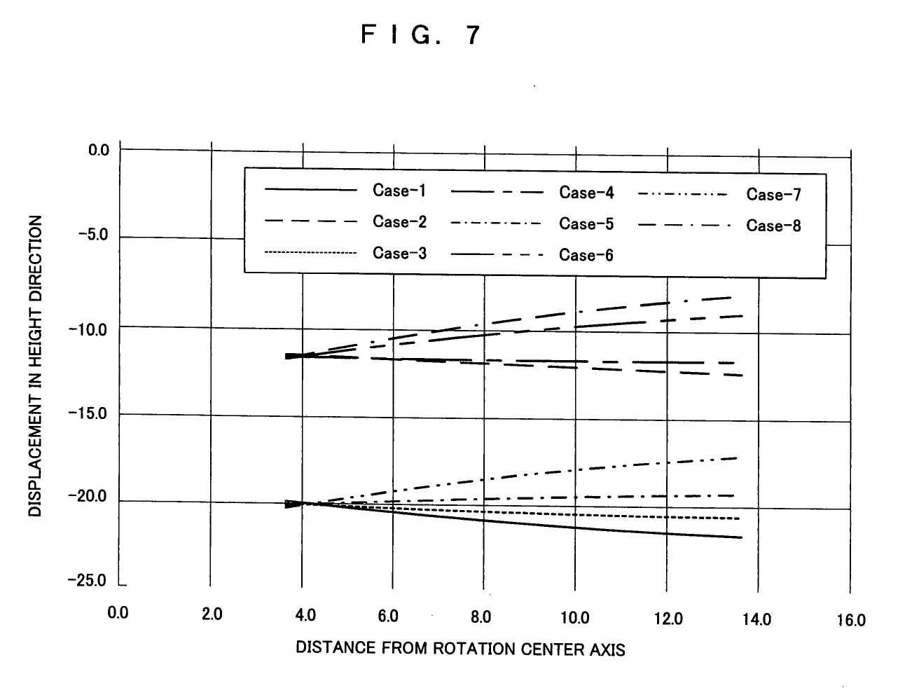

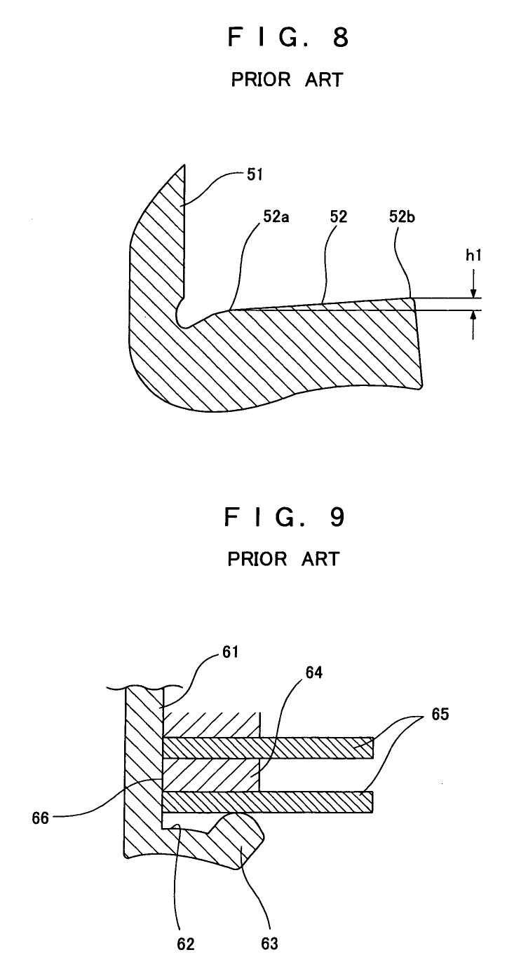

Table 1 shows inclinations caused in the disk recording medium 2 in a plurality of cases using different clamp position (distance a) and load F conditions in the arrangements shown in FIGS. 5 and 6. Cases 1 to 4 are cases of the arrangement shown in FIG. 5, while cases 5 to 8 are cases of the arrangement shown in FIG. 6. FIG. 7 is a graph showing the displacement (μm) of the disk recording medium 2 caused at different positions (at distances (mm) from the rotation center axis) in each case.

As is apparent from Table 1 and FIG. 7, in the two-point support arrangement shown in FIG. 5, the disk recording medium 2 is inclined so as to be lower in height on the outer peripheral edge side than the hub flange surface 21 independently of the distance a and load F conditions.

In the one-point support arrangement shown in FIG. 6, the disk recording medium 2 is inclined so as to be higher in height on the outer peripheral edge side than the hub flange surface 21 independently of the distance a and load F conditions.

In the two-point support arrangement, the largest inclination defined by −1.34 μm is exhibited when the distance a and the load F are maximized as shown with respect to case 1. When the distance a and the load F are minimized as shown with respect to case 4, the smallest inclination defined by −0.26 μm is exhibited. The inclination variation width under this condition is 1.08 μm.

In the one-point support arrangement, the largest inclination defined by 2.58 μm is exhibited when the distance a and the load F are minimized as shown with respect to case 8. When the distance a and the load F are maximized as shown with respect to case 5, the smallest inclination defined by 0.62 μm is exhibited. The inclination variation width under this condition is 1.96 μm.

Thus, it is apparent that the bending moment in the case of supporting the disk recording medium 2 by a plurality of disk supporting projections 28 between which the recess 27 is interposed, as in this embodiment, is smaller than that in the case of supporting the disk recording medium 2 by the sloping hub flange surface 21, as in the conventional art.

Also, in the present invention, the disk recording medium 2 is supported by the disk supporting projections 28 at two points as seen in the radial direction of the disk to impart the clamping force of the clamping device 22 to the disk recording medium 2 between the disk supporting projections 28.

Therefore, the straightness of the disk recording medium 2 can be maintained if the clamping device 22 contacts the disk recording medium 2 at any position in the region between the disk supporting projections 28.

That is, the load point on the disk surface to which the clamping force of the clamping device 22 is imparted may be set to any position in the region corresponding to the recess 27. Therefore, a reduction in the load position positioning accuracy may be allowed. Consequently, even if there is variation in the accuracy of a component, e.g., the clamp 23 of the claming device 22 or variation in clamping force of the clamping device 22, the desired straightness (horizontality) of the disk surface of the disk recording medium 2 can be easily maintained, thus reducing the occurrence of defectives and achieving an improvement in yield and a reduction in manufacturing cost.

TABLE 1

| | Shape of | | | | |
|---|---|---|---|---|---|
| | receiving | Clamp | | Inclination | Variation in |
| | surface | position | Load | (μm) | inclination |
| Case-1 | Recess | max | max | −1.34 | 1.08 |
| Case-2 | Recess | max | min | −0.66 | |
| Case-3 | Recess | min | max | −0.46 | |
| Case-4 | Recess | min | min | −0.26 | |
| Case-5 | Slope | max | max | 0.62 | 1.96 |
| Case-6 | Slope | max | min | 1.75 | |
| Case-7 | Slope | min | max | 2.07 | |
| Case-8 | Slope | min | min | 2.58 | |

What is claimed is:

1. A disk drive device comprising:
a spindle hub on which a disk recording medium is mounted; and
a clamping device for fixing the disk recording medium to the spindle hub, the spindle hub being fitted in a disk center hole formed at a center of the disk recording medium, the spindle hub having a hub flange surface on which a disk surface of the disk recording medium is supported concentrically with the disk center hole, the clamping device imparting a clamping force to the hub flange surface through the disk recording medium,
wherein a recess is formed in the hub flange surface concentrically with a rotation center axis of the spindle hub, and the hub flange surface contacts the disk surface at positions on opposite sides of the recess in a radial direction of the disk recording medium.

2. The disk drive device according to claim 1, wherein the clamping force of the clamping device is imparted to the disk recording medium at a position opposite from the recess in the hub flange surface.

3. The disk drive device according to claim 1, wherein the clamping device has a contact portion through which the clamping force is imparted to the disk recording medium, and the contact portion has a curved surface and contacts the disk recording medium in line contact in the curved surface.

4. A spindle motor comprising a spindle hub on which a disk recording medium is mounted, the spindle hub being fitted in a disk center hole formed at a center of the disk recording medium, the spindle hub having a hub flange surface on which a disk surface of the disk recording medium is supported concentrically with the disk center hole,
wherein a recess is formed in the hub flange surface concentrically with a rotation center axis of the spindle hub.
